(19) United States
(12) Patent Application Publication
(10) Pub. No.: US 2022/0308019 A1
(43) Pub. Date: Sep. 29, 2022

(54) DETERMINING APPROPRIATENESS OF A SAMPLE SEPARATION APPARATUS FOR EXECUTING AN OPERATION BY SIMULATION

(71) Applicant: Agilent Technologies, Inc., Santa Clara, CA (US)

(72) Inventors: Lena Höninger, Karlsruhe (DE); Uwe Effelsberg, Karlsruhe (DE); Gerhart Metzler, Waldbronn (DE); Sascha Lege, Baden-Wuerttemberg (DE); Konstantin Shoykhet, Karlsruhe (DE); Stephan Buckenmaier, Ettlingen (DE)

(21) Appl. No.: 17/698,732

(22) Filed: Mar. 18, 2022

(30) Foreign Application Priority Data
Mar. 25, 2021 (GB) 2104193.4

(51) Int. Cl. G01N 30/36; G01N 30/30

(52) U.S. Cl. CPC G01N 30/36; G01N 30/30; G01N 2030/022

(57) ABSTRACT

A process of controlling a sample separation apparatus for separating a fluidic sample includes determining whether the sample separation apparatus is appropriate for carrying out a predefined operation, by simulating the operation of the sample separation apparatus, and taking an action depending on a result of the determining.

### RELATED APPLICATIONS

This application claims priority to UK Application No. 2104193.4, filed Mar. 25, 2021, the entire contents of which are incorporated herein by reference.

### TECHNICAL FIELD

The present invention relates to a process of controlling a sample separation apparatus for separating a fluidic sample, a sample separation apparatus, a program element and a computer readable medium.

### BACKGROUND

Fluidic devices are used to execute various measurement tasks in order to measure any kind of physical parameter. Each fluidic device may have a specific driver with device specific commands. A programming software allows a user to design an operation mode of the fluidic device. As a result of such a design, the fluidic device may be operated in accordance with the designed operation mode.

More particularly, in liquid chromatography, a fluidic analyte may be pumped through a column comprising a material which is capable of separating different components of the fluidic analyte. Such a material, so-called beads, may be filled into a column tube which may be connected to other elements (like a control unit, containers including sample and/or buffers). Upstream of a column, the fluidic sample or analyte is loaded into the liquid chromatography apparatus. A controller controls an amount of fluid to be pumped through the liquid chromatography apparatus, including controlling a composition and time-dependency of a solvent interacting with the fluidic analyte. Such a solvent may be a mixture of different constituents. The supply of these constituents for subsequent mixing is an example of an operation to be designed by an operator of a liquid chromatography device.

However, developing a sample separation method, in particular a chromatographic method, may be cumbersome. Furthermore, it may happen that a sample separation apparatus is inappropriate for a certain sample separation task for which it is envisaged by a user. This may result in an inaccurate or even false separation result.

DE 102015112235 discloses a device for setting an operating point of a sample separation device for separating a fluidic sample. The device has a control device which is set up to adjust a temperature control of the sample separation device and/or a temperature control of the mobile phase to be supplied to flow through the sample separation device with any components of the fluidic sample contained therein based on information regarding an instantaneous axial temperature distribution along the sample separation device, in particular based on information regarding a temperature difference between different positions along the sample separation device. This may be done in order to at least partially compensate for an operating point shift caused by the axial temperature distribution, in particular an operating point drift, of the sample separation device.

DE 102017126893 discloses a sample separation device for separating a fluidic sample, the sample separation device having a control device which is designed to control the separation of the fluidic sample according to a separation method. The separation method is characterized by a parameter set with parameter values to be specified during the separation, and an expectation corridor with regard to parameter values which are established during the separation, which is indicative of a desired course of the sample separation.

### SUMMARY

It is an object of the invention to ensure that execution of an operation on a sample separation apparatus results in correct results and/or is performed without the danger of damage.

According to an exemplary embodiment, a process of controlling a sample separation apparatus for separating a fluidic sample is provided, wherein the process comprises determining whether the sample separation apparatus is appropriate for carrying out a predefined operation by simulating the operation of the sample separation apparatus, and taking an action depending on a result of the determining.

According to another exemplary embodiment, a sample separation apparatus for separating a fluidic sample is provided, wherein the sample separation apparatus comprises a fluid drive for driving a mobile phase and the fluidic sample when injected in the mobile phase, a sample separation unit for separating the fluidic sample in the mobile phase, and a control unit configured for controlling the sample separation apparatus by carrying out a process having the above-mentioned features.

According to still another exemplary embodiment of the invention, a program element (for instance a software routine, in source code or in executable code) is provided, which, when being executed by a processor (such as a microprocessor or a CPU), is adapted to control or carry out a method having the above mentioned features.

According to yet another exemplary embodiment of the invention, a computer-readable medium (for instance a CD, a DVD, a USB stick, a floppy disk or a hard disk) is provided, in which a computer program is stored which, when being executed by a processor (such as a microprocessor or a CPU), is adapted to control or carry out a method having the above mentioned features.

Data processing which may be performed according to embodiments of the invention can be realized by a computer program, that is by software, or by using one or more special electronic optimization circuits, that is in hardware, or in hybrid form, that is by means of software components and hardware components.

In the context of the present application, the term “sample separation apparatus” may particularly denote any apparatus which involves the transport, analysis or processing of fluids for separation of a fluidic sample. Examples for sample separation apparatuses are chemical analysis devices, life science apparatuses or any other biochemical analysis system such as a separation device for separating different components of a sample, particularly a liquid chromatography device. For example, the sample separation can be done by chromatography or by electrophoresis.

In the context of the present application, the term “fluid” may particularly denote a liquid and/or a gas, optionally comprising solid particles.

In the context of the present application, the term “fluidic sample” may particularly denote a medium containing the matter which is actually analyzed (for example a biological sample, such as a protein solution, a pharmaceutical sample, etc.).

In the context of the present application, the term “mobile phase” may particularly denote a fluid (in particular a liquid) which serves as a carrier medium for transporting a fluidic sample from a fluid drive (such as a high pressure pump) to a sample separation unit (such as a chromatographic column) of a sample separation apparatus. For example, the mobile phase may be a (for example, organic and/or inorganic) solvent or a solvent composition (for example, water and ethanol).

In the context of the present application, the term “fluid drive” may particularly denote an entity capable of driving a fluid, in particular the fluidic sample and/or the mobile phase. For instance, the fluid drive may be a pump (for instance embodied as piston pump or peristaltic pump) or another source of pressure. For instance, the fluid drive may be a high-pressure pump, for example capable of driving a fluid with a pressure of at least 100 bar, in particular at least 1000 bar.

The term “sample separation unit” may particularly denote a fluidic member through which a fluidic sample is transferred, and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample.

In the context of the present application, the term “predefined operation” may particularly denote a specific application, task, function, operation mode or operation in accordance with one or more operation parameters to be executed by the sample separation apparatus. For example, the predefined operation may be a separation of a specific fluidic sample by carrying out a specific sample separation method, or a process stage in the framework of such a separation. The operation may be carried out prior and thus in preparation of, during, and/or after the actual sample separation process. The predefined operation may be defined by one or more commands (for instance a command that a chromatographic separation of the fluidic sample should be executed in a gradient mode with a specifically defined gradient profile) to be executed by the sample separation apparatus and/or one or more parameter values (for instance a temperature value of a chromatographic separation column during sample separation) which may be adjusted by and/or present in the sample separation apparatus during the operation.

In the context of the present application, the term “determining whether the sample separation apparatus is appropriate for carrying out a predefined operation” may particularly denote an analysis, evaluation or estimation resulting in the conclusion whether execution of the predefined operation by the sample separation apparatus is possible without an expected or a predicted error, non-compliance with a predefined specification or boundary condition, damage of at least part of the sample separation apparatus and/or the fluidic sample, or presence of any operation state which is considered undesired or dangerous. For example, an inappropriateness of the sample separation apparatus for executing an operation may be an incapability of the sample separation apparatus to adjust a certain parameter value (for instance a desired flow rate of a mobile phase which cannot be delivered by a fluid drive of the sample separation apparatus) or to execute a separation method, may be an expected or predicted parameter value outside of a range of acceptable parameter values (for instance an expected pressure value which exceeds a maximum pressure which constituents of the sample separation apparatus can withstand), or may be a not yet confirmable operational readiness of the sample separation apparatus to carry out the operation (for instance when a parameter value, such as a temperature value, has not yet been reached a target temperature after switching on the sample separation apparatus or changing its set point).

In the context of the present application, the term “simulating an operation on a sample separation apparatus” may particularly denote a theoretical, mathematical, numerical and/or virtual analysis of how the sample separation apparatus would behave if the predefined operation was executed on the sample separation apparatus. In particular, the simulation may be done under consideration of properties of the sample separation apparatus, the mobile phase, the fluidic sample to be separated and/or parameter values being present during execution of the sample separation method. For instance, such a simulation may comprise a numerical analysis, such as a finite element or finite volume analysis.

In the context of the present application, the term “taking an action” may particularly denote taking measures concerning a way of proceeding or not proceeding with the operation of the sample separation apparatus in accordance with or depending on a result of the appropriateness determination. For example, taking an action may include a selection among different options or alternatives of a set of possible options or alternatives. As examples for actions which can be taken, a predefined operation being considered as appropriate in view of the simulation result may be executed, may be indicated to a user as acceptable, or operational readiness of the sample separation apparatus for carrying out the operation can be concluded or indicated. If the predefined operation is considered inappropriate due to a result of the simulation, exemplary actions which can be taken are that an execution of the predefined operation by the sample separation apparatus may be rejected, a warning may be output to a user, and/or an adaptation of the sample separation apparatus and/or the operation may be performed or proposed to achieve compliance or establish appropriateness.

According to an exemplary embodiment of the invention, a conformity check for a sample separation apparatus concerning its appropriateness for carrying out a predefined operation in terms of separating a fluidic sample can be carried out prior to, during and/or after the actual execution of said operation. By confirming or rejecting that the sample separation apparatus is suitable for an experimental execution of a predefined operation prior to the actual execution may prevent the sample separation apparatus and/or the fluidic sample from damage during execution of a specific operation. It may also be possible to avoid inaccurate or even false separation results resulting from the fact that the sample separation apparatus is not suitable for a certain sample separation task or is not yet ready for carrying out the sample separation task. A sample separation apparatus may also be considered as inappropriate for a predefined operation when the latter might probably result in parameter values out of acceptable ranges. Advantageously, exemplary embodiments of the invention may simulate theoretically a behavior of a sample separation apparatus when executing the predefined operation, in particular prior to its actual execution. Thereby, potential issues in terms of unsuitability may be identified prior to damage, wrong results or dangerous conditions. For this purpose, the process may simulate the considered operation when carried out on the sample separation apparatus for an early identification of potential issues. As a basis for the simulation, the sample separation apparatus and/or the fluidic sample and/or the predefined operation may be parameterized for evaluation by a simulation tool, which may for example carry out a numerical analysis. Based on the results of the simulation, an appropriate action may be taken, which may for instance indicate appropriateness or inappropriateness of the sample separation apparatus, and/or related conclusions (such as a warning or a confirmation output to a user) or measures (for example execution of the operation on the sample separation apparatus, or refusing or stopping execution thereof). When information indicative of an appropriateness or inappropriateness of the sample separation apparatus for carrying out the predefined operation has been determined by simulation, a corresponding feedback signal may be provided to a control unit of the sample separation apparatus for adjusting its operation to comply with one or more appropriateness criteria.

Next, further exemplary embodiments of the process, the sample separation apparatus, the program element and the computer readable medium will be explained.

In an embodiment, the process comprises and/or the control unit is configured for simulating a course over time of the operation executed on the sample separation apparatus. More specifically, the process may comprise and/or the control unit may be configured for simulating a course over time of at least one operation parameter when the operation is executed on the sample separation apparatus. Thus, a course of time (or a temporal course) of the (in particular desired) operation may be simulated, for example by simulating the course over time for one or more operation parameters relating to the (in particular desired) operation. In particular, it may be advantageously possible to run a simulation of a desired operation in order to determine whether such operation is appropriate, in particular whether such operation can be carried out on a specific HPLC instrument. For example, if a simulation of a desired separation process indicates that the present setup of the HPLC instrument is not suitable for carrying out such a separation, the desired operation will not be carried out, and the other way around.

In an embodiment, the process comprises and/or the control unit is configured for, when the result of the determining is that the sample separation apparatus is appropriate for carrying out the predefined operation, taking an action of at least one of the group consisting of indicating operational readiness for controlling the sample separation apparatus for carrying out the predefined operation, and carrying out the predefined operation. For instance, a display of a liquid chromatography sample separation apparatus or controlling unit may output to a user that, in view of a simulation result, the apparatus is now considered ready for starting with a separation run, since the simulation indicates that a heat-up or cool-down phase for bringing a chromatographic separation column to a target temperature in a column oven has been completed. It is also possible that the liquid chromatography sample separation apparatus waits with the execution of a separation run started by a user until completion of the heat-up or cool-down phase has been confirmed by the simulation.

In an embodiment, the process comprises and/or the control unit is configured for, when the result of the determining is that the sample separation apparatus is not appropriate for carrying out the predefined operation, taking an action of at least one of the group consisting of outputting a warning, stopping the sample separation apparatus, modifying the predefined operation for rendering the sample separation apparatus appropriate for carrying out the modified operation, and controlling the sample separation apparatus for not carrying out the predefined operation. For example, a warning may be output on a display of a liquid chromatography sample separation apparatus or controlling unit when a user has started a separation run, but the simulation shows that a heat-up phase is not yet complete. When an extrapolating simulation shows that execution of a sample separation method triggered by a user (for instance using a user-defined flow rate) will lead to a predicted parameter value out of an acceptable range (for example an excessive pressure value involving a danger of component damage), the sample separation apparatus may be stopped or an automatic adaptation may be carried out to avoid a predicted damage. For instance, simply warning a user that a flow rate is too high and may lead to a violation of a maximum pressure rule may be too slow to prevent damage, and an automatic reduction of the flow rate may be triggered to avoid damage. In case of severe predicted danger, the sample separation apparatus may even ignore a user command to start an operation to avoid defects or issues. For instance, the sample separation apparatus may automatically control a fluid valve to open for avoiding excessive pressure in such a scenario. Alternatively, the sample separation apparatus may invite a user to manually open a fluid valve for avoiding excessive pressure.

In an embodiment, the process comprises further determining whether the sample separation apparatus is appropriate for carrying out an alternative predefined operation, and taking an according action in dependence of a result of the further determining. Hence, an alternative operation can be analyzed by simulation, and if it turns out as appropriate, it can be accepted for execution on the sample separation apparatus.

In an embodiment, the process comprises and/or the control unit is configured for taking the action of delaying sample separation until the simulation indicates that at least one operation parameter has reached a predefined range of acceptance and/or has reached a predefined equilibrium state, in particular that a simulated temperature at a sample separation unit of the sample separation apparatus has reached a value within a predefined range of acceptance and/or has reached a predefined equilibrium state. A corresponding temperature simulation can be carried out for example as described in DE 102015112235 and/or DE102017126893. For simulating the temperature of a sample separation unit, a finite element or finite volume analysis may be carried out modeling the sample separation unit including its environment. For instance, ambient temperature, solvent, flow rate, material, geometry, stationary phase, pressure conditions of and at the sample separation unit may be included in the simulation, and the heat transfer to the sample separation unit and away from the sample separation unit may be considered as well. Also, the environment of the sample separation unit (such as a column oven, a preheater assembly, etc.) may be considered for the simulation. After starting or switching on a liquid chromatography sample separation apparatus, it may take a considerable time until the chromatographic separation column is at a constant target temperature. Starting a separation run before temperature equilibration at the sample separation unit has occurred may lead to wrong or inaccurate separation results. Since a temperature sensor cannot be placed easily in direct thermal contact with a stationary phase of the sample separation unit and a temperature sensor apart from the stationary phase is at least inaccurate for providing information concerning stationary phase temperature, a temperature simulation may be superior for gathering information concerning operational readiness of the sample separation apparatus for starting the separation run. Unless the temperature simulation indicates operational readiness, start of the separation run may be postponed to ensure that separation results are meaningful and accurate. For example, the temperature at the separation column may be simulated, and the sample separation apparatus will only output an indication to be ready for executing the operation when the simulation indicates that the column temperature has reached an equilibrium at a desired target temperature. In another embodiment, it is possible that the temperature at the separation column is simulated, and the sample separation apparatus will only start the predefined operation when the simulation indicates that the column temperature has reached an equilibrium at a desired target temperature.

In an embodiment, at least one parameter is considered for the simulation, but preferably all considered parameters have to satisfy a readiness goal or criterion. As further alternatives, at least one parameter, or at least a pre-defined sub-set of simulated operation parameters, or at least a pre-defined number of simulated parameters, or a sum of another function of deviations of a subset of the operating parameters from their respective target values, or a sum of another function of weighted deviations of the operating parameters from their respective target values, whereas the weighting factors may be pre-defined, may be considered in exemplary embodiments.

In an embodiment, the process comprises and/or the control unit is configured for determining by the simulation whether at least one operation parameter remains within a predefined range of acceptance during carrying out the predefined operation. For instance, a course or time dependence of an expected or predicted pressure value in the sample separation apparatus may be simulated on the basis of a given (for instance by a separation method to be executed) or set (for instance by a user) flow rate and/or on the basis of an initially measured pressure value. If the predicted pressure value is outside of a range of acceptable pressure values within which damage of constituents of the sample separation apparatus (for instance a chromatographic separation column) may be reliably prevented, an action (such as an output of a warning or a stop of the operation, or a countermeasure such as the reduction of the flow rate) may be taken.

In an embodiment, the process comprises and/or the control unit is configured for simulating a behavior of at least one operation parameter (such as temperature and/or pressure) at at least part of the sample separation apparatus (in particular at a sample separation unit such as a chromatographic separation column) during the operation. In the context of the present application, the term “operation parameter” may particularly denote a parameter of a set of multiple parameters defining a respective operation (in particular a separation method) and describing a property adjusted or occurring during operation of a sample separation apparatus when executing the operation (for instance the separation method). Such operation parameters can include in particular a physical separation condition, for instance mobile phase flow rate, solvent composition, pressure and/or temperature (in particular at a sample separation unit such as a chromatographic column), a wavelength of a detector, integration parameters, etc. A range of acceptance may be a function of time or another process progress descriptor, rather than a constant value or a fixed interval.

In particular, the process may comprise and/or the control unit may be configured for taking an action of at least one of the group consisting of indicating operational readiness for controlling the sample separation apparatus for carrying out the predefined operation, and carrying out the predefined operation, when at least one operation parameter is simulated and the behavior of all simulated operation parameters indicates that the sample separation apparatus is appropriate for carrying out the predefined operation, in particular that all simulated operation parameters remain within a predefined range of acceptance during carrying out the predefined operation. For instance, prediction of the temperature dependence and/or the pressure dependence at a sample separation unit over time by simulation may provide meaningful information concerning appropriateness of a sample separation apparatus for carrying out the separation method from a certain time onwards (in particular when the temperature at the sample separation unit has reached an equilibrium) or at all (for instance only if the expected pressure value remains below a not-to-exceed pressure limit).

In an embodiment, at least one parameter is under consideration and has to be appropriate. If multiple parameters are under consideration, preferably all parameters have to be appropriate. In particular, for starting the analysis all parameters should be ready, for stopping the analysis it may be sufficient that only one parameter is out of limit.

In an embodiment, the process comprises and/or the control unit is configured for simulating a behavior of the at least one operation parameter at a sample separation unit and/or in a region surrounding a sample separation unit, in particular at a chromatographic separation column and/or in a region surrounding a chromatographic separation column (for instance in an interior of a column oven), of the sample separation apparatus. The actual conditions at a sample separation unit during separating a fluidic sample are of utmost relevance for the accuracy and correctness of a sample separation result (such as a chromatogram, and in particular retention times or retention volumes of individual fractions of the fluidic sample to be separated). Hence, simulating the processes occurring at the sample separation unit during sample separation provides very meaningful information about the separation performance and is therefore highly indicative of the appropriateness of a sample separation apparatus, including its sample separation unit, for executing a separation method. Moreover, construction of a sample separation unit (such as a chromatographic separation column) in a temperature control chamber (such as a heating oven), optionally in combination with a preheater assembly for preheating mobile phase and/or fluidic sample directly upstream of the sample separation unit, may be taken into account for carrying out a precise finite element or finite volume analysis for simulating processes during sample separation. Hence, simulating the sample separation process executed by a separation unit of a sample separation apparatus by a finite element or finite volume analysis is a highly powerful tool for assessing appropriateness of a sample separation apparatus for a sample separation operation.

In an embodiment, the process comprises and/or the control unit is configured for predicting a behavior of at least one operation parameter, in particular predicting a delay time after which the at least one operation parameter will have reached a predefined equilibrium state, based on a result of the simulation. Thus, the simulation may extrapolate a present parameter condition to the future and may thus make predictions about an expectable parameter behavior. Thereby, potential issues in terms of inappropriateness may be identified at an early stage, so that countermeasures may be taken in due time before the issues actually occur.

In an embodiment, the process comprises and/or the control unit is configured for proposing or determining a modified operation of the sample separation apparatus, in particular a modified heating profile of a sample separation unit of the sample separation apparatus, based on a result of the prediction, in particular a modified operation for reducing the heat-up or wait time. For instance, in a scenario in which the simulation identifies that the temperature at a sample separation unit has not yet reached a target temperature and a thermal equilibrium so that a separation run leading to acceptable results cannot yet be expected, the simulation may allow to derive a proposal for a modified operation allowing a faster completion of an initial heating process.

In an embodiment, the simulation describes an asymptotic or quasi-steady-state of an apparatus or predicts a state of the apparatus at a certain point of time in the future (in the sense of providing a value and a predicted confidence interval of at least one of parameters describing the state of the apparatus) based on the boundary condition, that the control parameters of the apparatus have stayed unchanged since a known time duration.

In an embodiment, the simulation provides a value and a predicted confidence interval for at least one of parameters describing the state of the apparatus (for instance at a current moment or at a point of time in the future) based on the measured state of the apparatus at a certain point of time in the past.

In an embodiment, the simulation provides a value and a predicted confidence interval for at least one of parameters describing the state of the apparatus (for example at a current moment or at a point of time in the future) based on the knowledge of the history of the control parameters of the apparatus over a period of time preceding the moment of the simulation. The longer the known history preceding the simulation is, the more precise and accurate the simulation results can be.

In an embodiment, the process comprises and/or the control unit is configured for determining whether the sample separation apparatus is appropriate for carrying out a predefined operation in form of a separation method, in particular a chromatographic separation method, by simulating execution of the separation method on the sample separation apparatus for separating the fluidic sample. In the context of the present application, the term “separation method” may particular denote an instruction for a sample separation apparatus as to how to separate a fluidic sample, which is to be carried out by the sample separation apparatus in order to fulfill a separation task associated with the separation method. Such a separation method can be defined by a set of parameter values (for example temperature, solvent flow rate, pressure, characteristic of a solvent composition, etc.) and hardware components of the sample separation apparatus (for example the type of separation column used) and an algorithm with processes that are executed when the separation method is carried out. A corresponding set of technical parameters for operating the sample separation apparatus during sample separation may be stored in a database or memory accessible by a control unit controlling operation of the sample separation apparatus. Physical properties or operation parameters characterizing a separation method may involve a transport characteristic which may include parameters such as volumes, dimensions, values of physical parameters such as pressure or temperature, and/or physical effects such as a model of friction occurring in a fluidic conduit which friction effects may be modeled, for example, according to the Hagen Poiseuille law. More particularly, the parameterization may consider dimensions of a sample separation apparatus (for instance a dimension of a fluidic channel), a volume of a fluid conduit (such as a dead volume) of the sample separation apparatus, a pump performance (such as the pump power and/or pump capacity) of the sample separation apparatus, a delay parameter (such as a delay time after switching on a sample separation apparatus) of operating the sample separation apparatus, a friction parameter (for instance characterizing friction between a wall of a fluidic conduit and a fluid flowing through the conduit) of operating the sample separation apparatus, a flush performance (particularly properties related to rinsing or flushing the sample separation apparatus before operating it or between two subsequent operations) of the sample separation apparatus, and/or a cooperation of different components of the sample separation apparatus (for instance the properties of a gradient applied to a chromatographic column). When simulating execution of the separation method on a sample separation apparatus for separating a fluidic sample by parameterizing method, apparatus and/or sample, it is for instance possible to derive a theoretical chromatogram. Potential issues with such a separation run may be determined by simulation and may form the basis of a decision which action shall be taken.

In an embodiment, the process comprises and/or the control unit is configured for determining whether the simulated execution of the separation method on the sample separation apparatus results in a value of at least one operation parameter which is outside of a predefined range of acceptance. For instance, an unacceptably high pressure value at a sample separation unit resulting from a user-defined flow rate may be identified by simulation, so that an imminent danger may be cognized before it actually occurs, so that counter measures may be taken in due time.

In an embodiment, the process comprises and/or the control unit is configured for determining that the sample separation apparatus is not appropriate when the value is outside of the predefined range of acceptance. For instance, a maximum pressure (for example 1800 bar) which a chromatographic separation column may withstand may be defined in a specification of the chromatographic separation column and/or a separation method. When the simulation leads to a predicted pressure value above such a maximum allowed value, the sample separation apparatus may be classified as inappropriate for a corresponding operation.

In an embodiment, the process comprises and/or the control unit is configured for simulating execution of the separation method on the sample separation apparatus under consideration of at least one user input value of at least one operation parameter, in particular under consideration of a user input value relating to a flow rate. When a user inputs a desired value of an operation parameter, the system may simulate a consequence during operation of the sample separation apparatus occurring when the user input value would be in fact executed. If non-compliance of the sample separation apparatus and its desired operation with the user input value is identified, an inappropriateness of the sample separation apparatus with the user input value may be concluded. For instance, pressure damages may be avoided which may result from an excessively high user-defined flow rate of a mobile phase flowing through a separation path. For extrapolating the pressure development in view of a change of the flow rate, it may also be possible to further increase the accuracy of the conclusion by detecting the pressure (for instance using a pressure sensor) and use the detected pressure value for the simulation as initial or boundary condition.

In any of the above-mentioned embodiments, the at least one operation parameter may be a temperature, solvent flow rate and/or a pressure. However, other operation parameters, such as a detection wavelength of a detector, a solvent composition provided as a mobile phase, etc., may be considered as well. Preferably, at least one operation parameter relates to a sample separation unit of the sample separation apparatus. It has been found that the sample separation unit of a (in particular chromatographic) sample separation apparatus may be the most critical constituent of the sample separation apparatus for the accuracy and correctness of a sample separation result. Hence, simulating a behavior of the sample separation unit during execution of a predefined operation can be considered as a highly relevant source of information concerning appropriateness of the sample separation apparatus for executing the operation. Other constituents of the sample separation apparatus having a pronounced impact on a sample separation process are a fluid drive (such as a high-pressure pump) driving mobile phase and fluidic sample, and a detector for detecting the separated fluidic sample. Thus, additionally or alternatively to the sample separation unit, phenomena at the fluid drive and/or the detector may also form part of the simulation on the basis of which (in)appropriateness of the sample separation apparatus for carrying out the predefined operation is determined. However, the sample separation unit may require the longest time among all constituents of a sample separation apparatus to reach a steady state after starting or switching on a sample separation apparatus, or changing its setpoint, so that a simulation considering the sample separation unit may focus on the weakest link and may thereby provide the most meaningful results in terms of the appropriateness evaluation of the sample separation apparatus.

In an embodiment, the process comprises and/or the control unit is configured for determining by simulation whether the sample separation apparatus is ready for starting separation of the fluidic sample, and taking the action of indicating operational readiness for starting separation of the fluidic sample by the sample separation apparatus only after having determined, by the simulation, that the sample separation apparatus is ready for starting separation of the fluidic sample. For instance, operational readiness of the sample separation apparatus may be concluded only when the simulation indicates that a temperature of the sample separation unit has reached a stable target value inside the column. Unusable or inaccurate separation runs may thus be avoided.

In an embodiment, a desired ready condition may be defined not as a steady-state or most accurate condition, but rather as a typical condition resulting (for example by simulation or empirical measurement) from execution of the analytical method at least once. Optionally it can be a condition, which is achieved after a certain period of time or pre-defined set of operations (for example composition or flow rate adjustment) post end of the method execution. Thus, time intervals between the method executions may be reduced, or the precision of analytical results may be improved, or both, even if in such case the accuracy (i.e. correspondence to the set values) of certain parameters may be affected (either positively or negatively).

In an embodiment, the process comprises and/or the control unit is configured for determining by simulation that the sample separation apparatus is not appropriate for carrying out the predefined operation when a pressure value at at least part of the sample separation apparatus, in particular at a sample separation unit for separating the fluidic sample and/or at a detector for detecting the separated fluidic sample, obtained during simulated execution of the predefined operation of the sample separation apparatus is above at least one predefined pressure limit. By identifying that a sample separation apparatus or at least one constituent thereof (in particular a chromatographic separation column and/or a fluorescence detector) is not suitable to withstand a pressure value occurring according to the simulation during executing the operation of the sample separation apparatus, overpressure-based damage of such constituents may be avoided.

In an embodiment, the process comprises and/or the control unit is configured for carrying out the simulation for analyzing pressure under consideration of a flow rate related to the predefined operation. When a mobile phase is pumped with a given flow rate and concentration through the separation path, a numerical analysis or other kind of simulation may indicate that this flow rate leads to a certain pressure value. If the specification of the sample separation apparatus or a part thereof is incompatible with such a pressure value, the flow rate may be reduced for obtaining a sufficiently reduced pressure to avoid the incompatibility with the sample separation apparatus.

In an embodiment, the process comprises and/or the control unit is configured for determining whether the sample separation apparatus is appropriate for carrying out the predefined operation under consideration of a predetermined characteristic behavior of the fluidic sample, in particular under consideration of a predetermined transient response of the mobile phase after startup of the sample separation apparatus. Highly advantageously, not only the characteristic of the sample separation apparatus, but also an attribute of the mobile phase may be considered for the simulation leading to a conclusion concerning (in)appropriateness of the sample separation apparatus. In particular, also a transient response of the mobile phase may be introduced into the simulation, i.e. relating to a behavior of the mobile phase after starting or switching on a sample separation apparatus. Corresponding data may be obtained from a measurement or from a database.

In an embodiment, the process comprises and/or the control unit is configured for detecting detection data being indicative of a present value of at least one operation parameter at the sample separation apparatus, and determining whether the sample separation apparatus is appropriate for carrying out the predefined operation by simulating a future behavior of the at least one operation parameter during carrying out the operation under consideration of the detection data. Thus, based on a known present and/or past behavior, this behavior may be extrapolated by the simulation to make a prediction of the behavior during the course of the operation, in particular during the course of a sample separation process.

In an embodiment, the process comprises and/or the control unit is configured for determining whether the sample separation apparatus is appropriate for carrying out the predefined operation by simulating the process of separating the fluidic sample by the operation carried out on the sample separation apparatus. Hence, a theoretical course of the temperature, a theoretical course of the pressure, or a theoretical chromatogram or other kind of separation result may be derived by a numerical analysis.

In an embodiment, the process comprises and/or the control unit is configured for determining whether the sample separation apparatus is appropriate for carrying out the predefined operation by simulating a future behavior of at least one operation parameter when carrying out the operation on the sample separation apparatus with a presently modified value of the at least one operation parameter. Thus, the simulation may also estimate which influence a modification of one or more operation parameters (such as temperature, pressure, solvent composition and/or flow rate or the shape of a gradient profile) may have on the appropriateness of the sample separation apparatus for executing an operation.

In an embodiment, the process comprises and/or the control unit is configured for simulating by extrapolating a behavior of at least one operation parameter to the future based on a present and/or past behavior of the at least one operation parameter. Thus, a prediction can be made about potential issues in the future based on a present and/or past scenario. Already prior to an actual execution of the operation on the sample separation apparatus, such an extrapolating simulation (preferably by a finite element or finite volume analysis) may allow to theoretically identify potential issues in terms of appropriateness of a sample separation apparatus for a predefined operation.

In an embodiment, the process comprises and/or the control unit is configured for simulating the operation on the sample separation apparatus under consideration of at least one of the group consisting of empiric data, expert rules, a theoretical model, and a monitoring of an actual course of at least one operation parameter corresponding to the predefined operation. Empiric data may for instance be experimentally obtained data describing a past behavior of the sample separation apparatus when carrying out certain operations and/or when separating certain fluidic samples. Also empiric data concerning the fluidic sample and its attributes as well as its behavior during sample separation may be taken into account. Such information may be stored in a database and may be accessed in terms of the simulation. Expert rules may be generic or abstract criteria reflecting knowledge or experience of experts concerning sample separation. It may also be possible to theoretically model structure and/or behavior of the sample separation apparatus and to take into account corresponding information for the simulation. Furthermore, sensing one or more operation parameters in the sample separation apparatus (for instance using a temperature sensor, a pressure sensor and/or a flow rate sensor) may provide information which can be used for the determination.

In an embodiment, the process comprises and/or the control unit is configured for simulating the operation on the sample separation apparatus by carrying out a numerical analysis. In the context of the present application, the term “numerical analysis” may particularly denote algorithmic methods that use numerical approximation and/or algorithms for problems of mathematical analysis. A goal of numerical analysis when applied to simulations for deriving appropriateness conclusions is the design and analysis of techniques to give approximate but accurate solutions to hard problems relating to the evaluation of appropriateness of a sample separation apparatus in relation to a certain operation task. Numerical analysis may create, analyze and/or implement algorithms for obtaining numerical solutions to appropriateness judgment related problems involving continuous variables.

In an embodiment, the process comprises and/or the control unit is configured for carrying out the numerical analysis using at least one of the group consisting of a finite element method (FEM) analysis, a finite volume method (FVM) analysis, a finite difference method (FDM) analysis, a boundary element method (BEM) analysis, a control volume method (CVM) analysis, and a random walk method analysis.

A finite element method (FEM) may be preferred. In particular, a finite element method (FEM) can be implemented as a particular numerical method for solving partial differential equations in two or three space variables. To solve a problem, the FEM may subdivide a large system into smaller, simpler parts that are called finite elements. This may be achieved by a particular space discretization in the space dimensions, which may be implemented by the construction of a mesh of the object, i.e. the numerical domain for the solution which has a finite number of points. The finite element method formulation of a boundary value problem may finally result in a system of algebraic equations. The method may approximate the unknown function over the domain. The simple equations that model these finite elements may then be assembled into a larger system of equations that models the entire problem. For instance, a finite element method applied to a sample separation apparatus may spatially fractionize a sample separation unit (such as a chromatographic separation column) into a large plurality of volume elements.

For each volume element, the behavior may be calculated during execution of an operation such as a separation method. By taking this measure, the behavior of the entire system, i.e. of the entire sample separation unit may be simulated. Correspondingly, a mobile phase pump, a sample injector, etc. of a sample separation apparatus may be subject of a corresponding finite element analysis as well.

Additionally or alternatively, a finite volume method (FVM) may be executed. The finite volume method (FVM) is a method for representing and evaluating partial differential equations in the form of algebraic equations. In the finite volume method, volume integrals in a partial differential equation that contain a divergence term are converted to surface integrals, using the divergence theorem. These terms are then evaluated as fluxes at the surfaces of each finite volume.

Additionally or alternatively, a finite difference method (FDM) may be carried out which performs discretizations used for solving differential equations by approximating them with difference equations that finite differences approximate the derivatives. FDM may convert a linear ordinary differential equations or non-linear partial differential equations into a system of equations that can be solved by matrix algebra techniques.

Additionally or alternatively, a boundary element method (BEM) may be carried out which may be a numerical computational method of solving linear partial differential equations which have been formulated as integral equations. The integral equation may be regarded as an exact solution of the governing partial differential equation. The boundary element method attempts to use the given boundary conditions to fit boundary values into the integral equation, rather than values throughout the space defined by a partial differential equation. Once this is done, in a post-processing stage, the integral equation can then be used again to calculate numerically the solution directly at any desired point in the interior of the solution domain.

Additionally or alternatively, in a control volume method (CVM), a complete region may be subdivided into control volumes. Nodes may be located at the center of the control volumes. A statement of a conservation equation may be used to form difference equation, or the differential form of the conservation equation may be integrated over the control volume to form difference equation.

Additionally or alternatively, a random walk method may be carried out which may be considered as a mathematical object that describes a path that consists of a succession of random steps on a mathematical space, such as integers.

Particularly preferred may be the finite element analysis. However, also one or more of the other mentioned and/or further numerical analysis methods may be advantageously implemented, additionally or alternatively.

In an embodiment, the process comprises and/or the control unit is configured for additionally determining, in particular based on detecting detection data, whether an exterior manipulation of the sample separation apparatus influences appropriateness of the sample separation apparatus for carrying out the predefined operation, and taking an action when the result of the additional determination is that the manipulated sample separation apparatus is not or no more appropriate for carrying out the predefined operation. In particular when a user influences an operation parameter, the simulation may evaluate whether this intended change influences appropriateness of the sample separation apparatus for executing the predefined operation. For instance, such a user influence may be an adjustment of a temperature, a flow rate, a solvent or a solvent composition, and/or the substitution of a component of the sample separation apparatus (for instance a selection or a change of a detector, a separation column, etc.).

In an embodiment, the process comprises and/or the control unit is configured for taking an automated action, in particular reducing a flow rate, for again rendering the manipulated sample separation apparatus appropriate for carrying out the predefined operation, in particular for reducing a pressure below a predefined pressure limit. For instance in a scenario in which a user-defined modification of the operation of the sample separation apparatus—such as a sudden strong increase of the flow rate (for instance from 0.3 ml/min to 3 ml/min)—occurs, undesired or even dangerous phenomena—for instance a sudden pronounced pressure increase—may occur very quickly and may damage the sample separation apparatus or components thereof in a short time. When such a scenario is identified in which an action must be taken quickly to eliminate an imminent danger, the system may take immediate action without previous approval by the user. In the given example, the flow rate should be immediately decreased to avoid an overpressure which would otherwise destroy the sample separation unit, the detector, etc.

Embodiments may be implemented in conventionally available HPLC systems, such as the analytical Agilent 1290 Infinity II LC system or the Agilent 1290 Infinity II Preparative LC/MSD system (both provided by the applicant Agilent Technologies—see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump may be configured to know (by means of operator's input, notification from another module of the instrument or similar) or elsewise derive solvent properties.

The sample separation unit of the sample separation apparatus preferably comprises a chromatographic column (see for instance en.wikipedia.org/wiki/Column_chromatography) providing a stationary phase. The column may be a glass or steel tube (for instance with a diameter from 50 μm to 5 mm and a length of 1 cm to 1 m) or a microfluidic column (as disclosed for instance in EP 1577012 or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Also possible are ion exchange chromatography, reversed-phase chromatography (RP), affinity chromatography or expanded bed adsorption (EBA). The stationary phases are usually finely ground powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation water and organic solvent are delivered in separate bottles, from which the gradient pump delivers a programmed blend to the system. Other commonly used solvents may be isopropanol, THF, hexane, ethanol and/or any combination thereof or any combination of these with aforementioned solvents.

The fluidic sample may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation apparatus, for instance an HPLC system, may further comprise a detector for detecting separated compounds of the fluidic sample, a fractionating unit for outputting separated compounds of the fluidic sample, or any combination thereof.

Embodiments of the invention can be partly or entirely embodied or supported by one or more suitable software programs (or software), which can be stored on or otherwise provided by any kind of non-transitory medium or data carrier, and which might be executed in or by any suitable data processing unit such as an electronic processor-based computing device (or system controller, control unit, etc.) that includes one or more electronic processors and memories. Software programs or routines (e.g., computer-executable or machine-executable instructions or code) can be preferably applied in or by the control unit. For example, one embodiment of the present disclosure provides a non-transitory computer-readable medium that includes instructions stored thereon, such that when executed on a processor, the instructions perform the steps of the method of any of the embodiments disclosed herein.

### BRIEF DESCRIPTION OF DRAWINGS

Other objects and many of the attendant advantages of embodiments of the present invention will be readily appreciated and become better understood by reference to the following more detailed description of embodiments in connection with the accompanying drawings. Features that are substantially or functionally equal or similar will be referred to by the same reference signs.

FIG. 1 shows a liquid sample separation apparatus in accordance with embodiments of the present invention, particularly used in high performance liquid chromatography (HPLC).

FIG. 2 shows construction of a temperature control chamber accommodating a sample separation unit which can be used as a basis for a finite element-related simulation of a separation operation of a sample separation apparatus according to an exemplary embodiment.

FIG. 3 shows a chromatogram with individual curves obtained in different consecutive separation runs indicating a peak-related retention time differing for one of the curves from the others.

FIG. 4 shows a temperature difference between a first injection and a second injection in a chromatographic separation column obtained by simulation according to an exemplary embodiment.

FIG. 5 shows a flowchart of a process according to an exemplary embodiment.

The illustration in the drawing is schematic.

### DETAILED DESCRIPTION

Before describing the figures in further detail, some basic considerations of the present invention will be summarized based on which exemplary embodiments have been developed.

According to an exemplary embodiment of the invention, a simulation (for instance by numerical analysis such as a finite element analysis) of a predefined operation (such as a separation method) by a sample separation apparatus (in particular a liquid chromatography sample separation apparatus) is carried out for obtaining information being indicative of whether or not the sample separation apparatus is appropriate for carrying out the operation. Based on the results of this simulation and conclusion, an appropriately selected action may be taken (for instance control of the sample separation apparatus may be adjusted accordingly, execution of the operation may be triggered, postponed or refused, an alarm may be output, etc.).

According to an exemplary embodiment of a first aspect of the invention, it may be possible to determine whether a sample separation apparatus is in a “ready state”, i.e. is actually ready for example to perform a certain separation method. For example, if the user wants to run a certain separation method, the sample separation apparatus can indicate that it needs a certain time (for example five minutes) until being ready for running that separation method, and/or the sample separation apparatus may actively enact to come to such ready state for running such a separation method. A gist of an exemplary embodiment of invention is to recognize when a sample separation apparatus is actually ready for operation, so that a particular separation method can also be executed safely. Conventional HPLC devices may show a “ready to go”, although the device is not completely “turned in”, so many users (as a workaround) simply run the device for a while before they actually use it. This may be inefficient and may deliver partially wrong results. To overcome such shortcomings, an embodiment of the invention may actively influence the sample separation apparatus so that it is then (for example at a certain time) actually ready for operation. In an alternative embodiment, a prediction can be made as to when the sample separation apparatus will be “actually ready for operation”.

According to an exemplary embodiment of a second aspect of the invention, it may be possible to determine whether a sample separation apparatus is “suitable” for carrying out a certain separation method (before actually operating such a separation method). For example, if the sample separation apparatus finds that running a certain separation method would lead to pressure values outside a rated pressure range, the sample separation apparatus may signal this to the user. A gist of an exemplary embodiment is to estimate expected pressure values for a particular separation method by simulation, and accordingly whether a particular sample separation apparatus (such as an HPLC device) is suitable for performing this separation method, i.e. whether the expected pressure values exceed the maximum pressure range of the sample separation apparatus. A corresponding simulation can also be carried out for parameters other than the pressure, for example in terms of temperature. For the simulation, all possible data can be taken into account, such as historical data, but also current measurements. Accordingly, trends can also be identified or derived. Such a simulation can be performed in particular before a respective run (for instance as a test), but also for example in separation method development.

According to an exemplary embodiment of a third aspect of the invention, it may be possible to determine whether a sample separation apparatus is “suitable” to be operated for example by a user provided operation parameter, before executing an operation using such an operation parameter. For example, if the user selects a value of a flow rate which could harm the sample separation apparatus, the sample separation apparatus may give notice to the user (for example may output “Do you really want to select that parameter?”). A gist of such an embodiment of the invention is to provide a plausibility check before carrying out a user defined apparatus setting. Such a plausibility check may be a lookup whether a rated range, for example a maximum pressure, would be exceeded by such an apparatus setting applied by the user. However, more sophisticated analysis may be applied, in particular simulation. For example, a finite element (FEM) simulation of a separation method may be performed in order to evaluate whether the sample separation apparatus is suitable to run such a separation method. This may include simulating the response of the sample separation apparatus for a given separation method. Moreover, it may be possible in an embodiment to derive a potential response of the sample separation apparatus for a given parameter change from historic data. For instance, this may be embodied as a lookup. Apart from this, a history or data driven flow reduction may be adjusted in the event of an uncontrolled or unexpected behavior (for example when closing a manual valve or blockage of the flow path with particles).

According to an exemplary embodiment of the invention, it may be determined whether a sample separation apparatus is suitable for executing a certain operation (for example running a certain separation method, being operated with a certain parameter, etc.) in view of a current or an actual setup (in particular hardware configuration) of the sample separation apparatus, and taking an action such as providing a signal (for example outputting a warning) in case the separation apparatus is not suitable for executing such operation. Such determining may be based on a simulation, and may take into account historical data, monitoring an actual course of a parameter (for example monitoring a pressure rise after a user has opened a valve and concluding that a further pressure rise may harm the sample separation apparatus), etc. Also, such determining may be static (for example before a desired operation) or dynamic (for example during a current operation). “Suitable” or “appropriate” for executing a certain operation may be that the sample separation apparatus is ready for such operation, the hardware of such a sample separation apparatus is suitable for such operation within its rated mode of operation, etc.

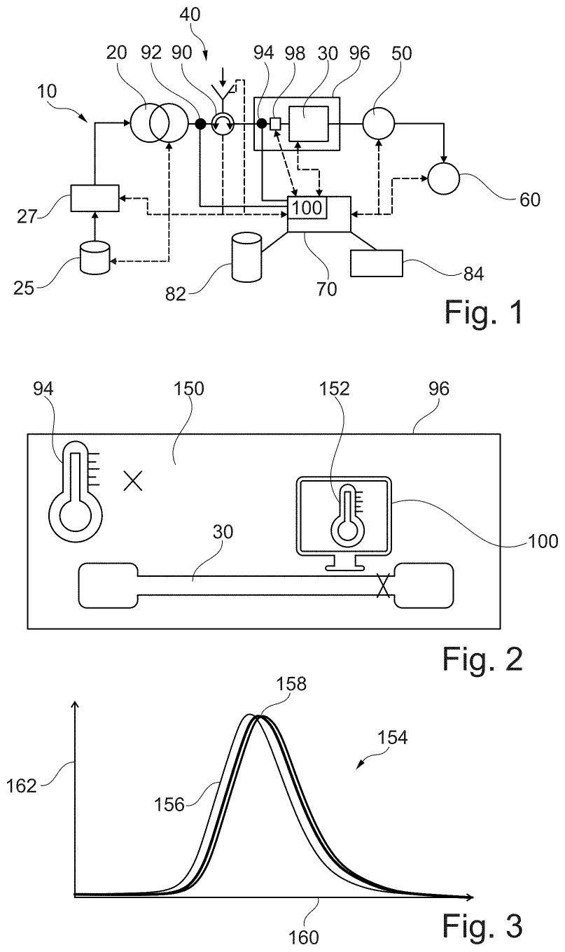

Referring now in greater detail to the drawings, FIG. 1 depicts a general schematic of a liquid separation system as example for a sample separation apparatus 10 according to an exemplary embodiment of the invention. A fluid drive 20 (such as a piston pump) receives a mobile phase from a solvent supply 25 via degassing unit 27, which degases and thus reduces the amount of dissolved gases in the mobile phase. The fluid drive 20 drives the mobile phase through a separation unit 30 (such as a chromatographic column) comprising a stationary phase. A sampler or injector 40, implementing a fluidic valve 90, can be provided between the fluid drive 20 and the separation unit 30 in order to subject or add (often referred to as sample introduction) a sample fluid into the mobile phase so that a fluidic sample and mobile phase may be provided towards a separation path where actual sample separation occurs. The stationary phase of the separation unit 30 is configured for separating compounds of the sample liquid. A detector 50 is provided for detecting separated compounds of the sample fluid. A fractionating unit 60 can be provided for outputting separated compounds of sample fluid. It is also possible to provide a waste (not shown).

While the mobile phase can be comprised of one solvent only, it may also be mixed from plural solvents. Such mixing may be a low pressure mixing and provided upstream of the fluid drive 20, so that the fluid drive 20 already receives and pumps the mixed solvents as the mobile phase. Alternatively, the fluid drive 20 may comprise plural individual pumping units, with plural of the pumping units each receiving and pumping a different solvent or mixture, so that the mixing of the mobile phase (as received by the separation unit 30) occurs at high pressure and downstream of the fluid drive 20 (or as part thereof). The composition of the mobile phase may be kept constant over time, the so called isocratic mode, or varied over time, the so called gradient mode.

A data processing unit or control unit 70, which can be a PC or workstation, and which may comprise one or more processors 100, may be coupled (as indicated by the dotted arrows) to one or more of the devices in the sample separation apparatus 10 in order to receive information and/or control operation. For example, the control unit 70 may control operation of the fluid drive 20 (for example setting control parameters) and receive therefrom information regarding the actual working conditions (such as output pressure, etc. at an outlet of the pump). Optionally, the control unit 70 may also control operation of the solvent supply 25 (for example setting the solvent/s or solvent mixture to be supplied) and/or the degassing unit 27 (for example setting control parameters and/or transmitting control commands) and may receive therefrom information regarding the actual working conditions (such as solvent composition supplied over time, vacuum level, etc.). The control unit 70 may further control operation of the sampling unit or injector 40 (for example controlling sample injection or synchronization of sample injection with operating conditions of the fluid drive 20). The separation unit 30 may also be controlled by the control unit 70 (for example selecting a specific flow path or column, setting operation temperature, etc.), and send—in return—information (for example operating conditions) to the control unit 70. Accordingly, the detector 50 may be controlled by the control unit 70 (for example with respect to spectral or wavelength settings, setting time constants, start/stop data acquisition), and send information (for example about the detected sample compounds) to the control unit 70. The control unit 70 may also control operation of the fractionating unit 60 (for example in conjunction with data received from the detector 50) and provide data back.

Along the flow path of the mobile phase, one or more sensors 92, 94 may be provided, for instance a pressure sensor 92 and a temperature sensor 94. Each of the sensors 92, 94 may supply a sensor result to the control unit 70.

The above described sample separation unit 30, here configured as chromatographic separation column, is arranged inside of a temperature control chamber 96, such as a column oven. Fluidic sample and/or mobile phase pumped by the fluid drive 20 may be preheated in a preheater assembly 98 arranged upstream of the sample separation unit 30 inside of the temperature control chamber 96.

The control unit 70 may be coupled with a database 82 (such as an electronic mass storage device, for instance a hard disk) with read and/or write access. In the database 82, information needed by the control unit 70 and its processor 100 for carrying out the below described computations, and particular simulations, may be stored. Stored data may include historic data concerning sample separation processes, data sets relating to one or more separation methods, data relating to theoretical models, data sensed by sensors 92, 94, etc. Furthermore, the control unit 70 is coupled with an input/output unit 84 by which a user can communicate with the sample separation apparatus 10. For instance, information (for example a warning, measured and/or simulated parameters, etc.) may be displayed to the user on a display of the input/output unit 84. Beyond this, the input/output unit 84 may comprise input elements, such as a touchscreen, a keypad, etc. Via the input elements, a user may input commands (for instance a command to start a separation run) and/or parameter values (such as a desired flow rate).

The control unit 70, and in particular its processor 100, may be configured for executing a process of controlling a sample separation apparatus 10 for separating a fluidic sample by executing a chromatographic separation method. In the context of this control, the control unit 70 may determine whether the sample separation apparatus 10 is appropriate or suitable for carrying out such a user-selected separation method for separating the fluidic sample. This determination may be based on a simulation of the execution of the separation method on the sample separation apparatus 10, for instance by modeling and analyzing the sample separation apparatus 10 or part thereof and by carrying out a corresponding numerical analysis. Preferably, said numerical analysis may be a finite element (FEM) analysis of the sample separation unit 30 in the temperature control chamber 96. The latter mentioned finite element analysis may be particularly preferred, since the sample separation unit 30 may be considered as the weakest link in terms of temperature equilibrium of the entire sample separation apparatus 10, so that simulation results relating to this particular region may be of particularly high relevance. Based on the results of the simulation, the control unit 70 may take an action depending on or in accordance with a result of the determining. Such an action may be that the control unit 70 outputs via the input/output unit 84 the information indicating operational readiness for starting a separation run by executing the separation method on the sample separation apparatus 10. Another action which can be taken when the appropriateness of the sample separation apparatus 10 for carrying out the separation method is confirmed by the simulation is that execution of the separation method on the sample separation apparatus 10 is triggered automatically and without user interaction. If however the result of the determining is that the sample separation apparatus 10 is not appropriate for carrying out the separation method, the taken action may for example be the output of a corresponding warning via the input/output unit 84. In this scenario, it is also possible to stop execution of the separation method on the sample separation apparatus 10, to modify one or more operation parameters (such as a modification of the flow rate, a solvent composition, a gradient profile, etc.) of the separation method for rendering the sample separation apparatus 10 appropriate for carrying out the modified separation method.

In yet another embodiment, the control unit 70 may take the action of delaying sample separation until the simulation indicates that a temperature at the sample separation unit 30 in the temperature control chamber 96 has reached a predefined target temperature and that the target temperature is stable, i.e. does no longer vary over time. A chromatographic separation result is strongly dependent on the temperature of the sample separation unit 30, so that postponing the start of the sample separation until a temperature equilibrium has been reached may increase the accuracy of the separation result. The control unit 70 may assume that the temperature equilibrium has been reached in the sample separation unit 30 when the simulation indicates this. Operational readiness for controlling the sample separation apparatus 10 for carrying out the separation method may be indicated via the input/output unit 84 to a user as soon as the simulated temperature behavior at the sample separation unit 30 indicates that the sample separation apparatus 10 is now appropriate for carrying out the separation method. Furthermore, the control unit 70 may check, for instance by a further simulation and/or based on sensor data detected by sensor 94, whether the temperature at the sample separation unit 30 remains stable during carrying out the separation method. In this context, the simulation executed by the control unit 70 may also predict a temperature behavior at the sample separation unit 30, and may predict a delay time after which the temperature at the sample separation unit 30 will have reached a target temperature and an equilibrium state. When the simulation carried out by the control unit 70 identifies that a temperature equilibrium at the sample separation unit 30 will only be reached after a certain time, the control unit 70 may propose to the user via the input/output unit 84 a modified heating profile of a sample separation unit 30 of the sample separation apparatus 10 for reducing the delay time.

The described simulation carried out by the control unit 70 may comprise the calculation of the course of the temperature inside the separation unit 30, and/or the course of the pressure inside the separation unit 30, or a chromatogram obtained when carrying out the separation method for separating a specific fluidic sample on the sample separation apparatus 10. More generally, a simulation of the execution of the separation method on the sample separation apparatus 10 for separating the fluidic sample may be performed in order to collect information allowing to judge appropriateness or inappropriateness of the sample separation apparatus 10 for carrying out the separation method.

It is also possible that the control unit 70 carries out a simulation for determining whether the simulated execution of the separation method on the sample separation apparatus 10 results in a pressure value which is outside of a predefined range of acceptance. The individual constituents of the sample separation apparatus 10 according to FIG. 1, for instance the sample separation unit 30, may be pressure sensitive and may withstand only pressure values below a specified value. When for instance a user inputs via the input/output unit 84 a desired flow rate, for instance increased by a factor of 10, the control unit 70 may calculate a predicted pressure assuming that the flow rate is in fact increased accordingly. For this simulation or extrapolation, it is also possible to consider a present pressure value, as sensed by pressure sensor 82. For this purpose, it may be possible to simulate a future behavior of the pressure value during carrying out the separation method under consideration of a detected pressure value, for instance an initial pressure value. The control unit 70 may determine that the sample separation apparatus 10 is not appropriate when the predicted pressure value is outside of the predefined range of acceptance. In this case, the control unit 70 may output a corresponding warning via the input/output unit 84, and/or may refuse the user defined increase of the flow rate to prevent damage.

Advantageously, the control unit 70 may also take into account properties of the fluidic sample and/or of a mobile phase for the simulation. For instance, it may be possible that the control unit 70 determines whether the sample separation apparatus 10 is appropriate, is already appropriate, or is inappropriate for carrying out the separation method under consideration of a predetermined characteristic behavior of the mobile phase, for instance a predetermined transient response of the mobile phase after startup of the sample separation apparatus 10.

FIG. 2 shows construction of a temperature control chamber 96 accommodating a sample separation unit 30 which can be used as a basis for a finite element-related simulation of a separation operation of a sample separation apparatus 10 according to an exemplary embodiment. Hence, FIG. 2 is a sketch of a temperature control chamber 96, embodied as column oven, that contains a chromatographic column as sample separation unit 30, and a temperature sensor 94. The temperature may be measured in surrounding air 150, or at a heat block. According to an exemplary embodiment of the invention, it is possible to simulate the temperature directly at the position of the chromatographic column (additionally or alternatively to the temperature measurement by temperature sensor 94). This processor-based simulation is indicated schematically by reference sign 152 in FIG. 2.

FIG. 3 shows a chromatogram 154 with individual curves 156, 158 obtained in different consecutive separation runs indicating a peak-related retention time differing for one curve 156 from the other curves 158. The chromatogram 154 according to FIG. 3 has an abscissa 160 along which the time is plotted. Along an ordinate 162, a detector signal, as detected by detector 50, is plotted. FIG. 3 illustrates a chromatogram of a sequence with six consecutive runs. The retention time of the first peak (see reference sign 156) differs from the other ones (see reference sign 158). A reason for this fact is that the temperature at the position of the sample separation unit 30 in the temperature control chamber 96 (compare FIG. 2) has not yet reached an equilibrium at the first captured chromatogram according to reference sign 156, and thereby provides an inaccurate or wrong retention time. According to an exemplary embodiment of the invention, the temperature at the sample separation unit 30 may be simulated (see reference sign 152 in FIG. 2) rather than being measured only (to avoid the above described inaccuracy), and the decision about a start of the execution of the separation method on the sample separation apparatus 10 or an indication of an operational readiness to start may be taken depending on the simulation result. When the simulation indicates that a stable target temperature has been reached at the position of the sample separation unit 30, this may trigger the aforementioned action.

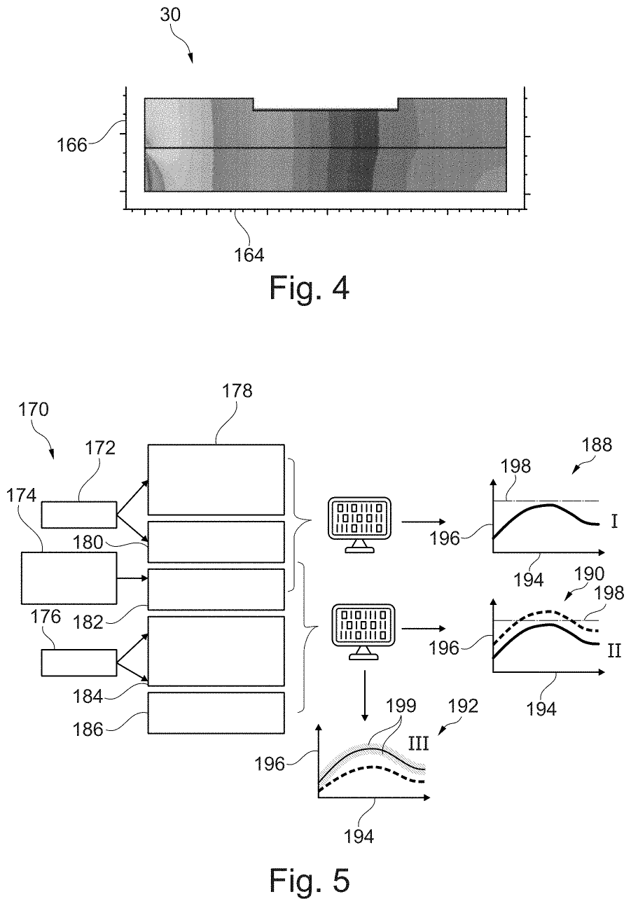

FIG. 4 shows a temperature difference between a first injection (or separation run) and a second injection (or separation run) in a chromatographic separation column 30 obtained by simulation (see reference sign 152 in FIG. 2) according to an exemplary embodiment. Thus, FIG. 4 plots a simulated temperature difference between the first and second injections in the chromatographic column, where the temperature difference value is encoded by a color-scale with steps of 0.01 degree. The spatially resolved temperature distribution according to FIG. 4 has an abscissa 164 along which a spatial position along the axial extension of the sample separation unit 30 in flow direction is plotted. Along an ordinate 166, a spatial position along a radial extension of the sample separation unit 30 perpendicular to the flow direction is plotted. The information derivable from FIG. 4, obtained by an FEM analysis taking into account the system shown in FIG. 2, is indicative of whether or not a thermal equilibrium has already been reached along the extension of the sample separation unit 30. For example, a threshold criterion may be applied based on the information according to FIG. 4 to decide whether the sample separation apparatus 10 is already ready to start a meaningful separation run, or not.

Thus, an embodiment as the one described referring to FIG. 2 to FIG. 4 may determine a real ready state of sample separation unit 30 (such as a chromatographic column) in a temperature control chamber 96 (such as a column oven) of a for instance liquid chromatography-based sample separation apparatus 10.

In a conventional approach, a temperature sensor in the column oven measures the air temperature or the temperature at a heat block or air. The system switches to “ready” as soon as the target air temperature is reached. But at this point of time, the chromatographic column is not yet in thermal equilibrium, which is important for a stable performance of a chromatographic separation. Experienced users may know to wait (much) longer after the ready signal before starting the run. However, this requires that the user have specific chromatographic skills and experience. Furthermore, this leads to a waste of time.

A result of the conventional approach may be a deviating first injection: The thermal conditions inside the column change during an analysis with a solvent gradient. The heat that is generated depends on the solvent composition that varies within a gradient. As the viscosity and compressibility of the mixture changes, so does the influence of frictional heating. Therefore, the first injection may be different in a set of consecutive runs, as the starting temperature is different (compare FIG. 3). Experienced users know to do a blank run at the beginning of a sequence or discard the results of the first run. Again, this requires that the user have specific chromatographic skills and experience.

In the following, it will be described how a real ready state of the sample separation apparatus 10 may be determined according to an exemplary embodiment of the invention. Such embodiments may be based on a simulation of the temperature inside the sample separation unit 30 (such as a chromatographic column), which may advantageously improve the ease of use of the sample separation apparatus 10 (for instance a liquid chromatography system) while simultaneously ensuring reliable and accurate results.

Such a system may work as follows: From the result of the simulation, the sample separation apparatus 10 may know when it is in real thermal equilibrium and may delay the start of an analysis until the simulation indicates that an equilibrium is reached. In a multi-run sequence, the sample separation apparatus 10 can predict the conditions after a gradient run and can adjust even before the first run. Moreover, the sample separation apparatus 10 can predict the time it needs to reach the desired equilibrium. Furthermore, the simulation may offer a heat up path to reach the equilibrium faster. The control unit 70 may control the sample separation apparatus 10 correspondingly.

The described embodiment has advantages: Firstly, the ease of use of operating the sample separation apparatus 10 may be improved without compromising on accuracy. Secondly, no special experience and skills of a user are needed. Even less experienced users may be enabled to achieve high quality results. Furthermore, there is no need of additional blank runs, which saves time and resources (in particular solvents). Apart from this, there is no need to discard the first run(s) or injection(s). Reliable separation results may be achieved faster. Beyond this, the sample separation apparatus 10 may make a meaningful time estimation when an equilibrium (in particular a thermal equilibrium) will be reached (in particular at the sample separation unit 30).

Next, a more detailed description of the construction and operation of a corresponding sample separation apparatus 10 according to an exemplary embodiment of the invention will be described:

1. When the sample separation apparatus 10 knows attributes of the sample separation unit 30 (in particular column dimensions, for example via tag reading), a simulation can calculate the temperature profile within the sample separation unit 30 (in particular along the column bed, preferably including solvent composition and/or frictional heating) and predict the equilibrium temperature and the time needed to reach that temperature. Only then does the sample separation apparatus 10 switch to “ready” when the sample separation unit 30 (in particular the column bed) is in equilibrium.

2. The simulation may calculate the thermal conditions that will occur after the first separation run and sets them before the first injection.

3. The simulation may allow to choose a heating profile that can reach equilibrium faster.

4. A time dependent simulation may allow to estimate the time needed to reach the target temperature.

FIG. 5 shows a flowchart 170 of a process according to an exemplary embodiment. In particular, the embodiment of FIG. 5 may make a pressure prediction by carrying out an FEM simulation of the chromatography system.

Each module of the sample separation apparatus 10, including the sample separation unit 30 (in particular a chromatographic column) may have an operating pressure limit. During an analysis, the pressure can vary due to increased restriction, like adding a sample loop of injector 40 into the flow path, a change of viscosity due the gradient, etc.

To protect said modules including said column, a conventional approach is to check the pressure and to shut down the pump if a threshold is reached, resulting in a failed analysis. Leakages may be detected by sensors that detect the leaked solvents. However, smaller amounts are not detected or only after a longer period.

According to exemplary embodiment of the invention, a prediction of the resulting backpressure may be made through simulation. This may help a user to detect errors, such as leakages, and to find methods that are not compatible with the system status, in particular before a separation run is started.

Advantageously, a failed analysis due to excessive pressure may be reliably prevented. Furthermore, an increased ease of use may be achieved even for less experienced users without specific skills in the field of liquid chromatography. Advantageously, it is no longer necessary that a user estimates which separation method is suitable for a respective set-up, without any guidance. Apart from this, a faster error detection may become possible. Shutdowns that result in failed analysis may be prevented, with the loss of sometimes rare or expensive sample and down time of the sample separation apparatus 10.

Next, construction and operation of a corresponding embodiment of the invention will be explained:

The prediction of a backpressure in the sample separation apparatus 10 may be done by carrying out an FEM simulation of the chromatographic process. The basis for this calculation may be input parameters (such as column dimensions) given by tags (see block 172 in FIG. 5), by the user (such as method parameters, compare block 174) and sensors 92, 94 (such as actual pressure sensors, see block 176). Referring to block 172, the tag may provide nominal module parameters 178 (such as inner dimensions, capillary lengths, etc.) and nominal column parameters 180. What concerns block 174, information programmed by a user may include method parameters 182 (such as solvent composition, flow rate, etc.). Referring to block 176 information provided by sensors include actual module parameters 184 (such as system backpressure, blockages like filter clog over time, etc.) and column clogging over time (see block 186).

Such an embodiment may in particular have three applications I, II, III in a liquid chromatography workflow, as indicated in FIG. 5. These applications will be described in the following referring to diagrams 188, 190 and 192, each plotting the time along an abscissa 194 and a pressure along an ordinate 196.

What concerns application I, the expected backpressure (indicated by a solid line in diagram 188) during method setup may be calculated by the parameters flow rate, composition, and nominal restriction of modules and column. The diagram shows the case, where the predicted pressure stays below the limit-pressure (indicated by a dash-dotted line 198). In the other case, if the expected backpressure exceeds a maximum pressure limit 198, a warning can be output before the separation run is even started. For instance, a display of the input/output unit 84 may indicate “This method will fail due to the high-pressure limit”.

Now referring to application II, the backpressure can be calculated even more precisely at the start of an analysis or separation run, for instance during flush-in, as this may allow to include the actual restrictions of the system, the column (clog over time), blockages (for example filter clog over time) and temperature. The control unit 70 of the sample separation apparatus 10 can simulate the pressure gradient throughout the time of the analysis or separation run. Also, historic data can be used to extrapolate the behavior of the sample separation apparatus 10 and may help to predict the resulting pressure in the future. The diagram 190 shows the case, where the predicted pressure (dashed line), predicted using sensor data and/or historic data, is increased in relation to application I (solid line, compare to diagram 188), using only nominal parameters for predication. This time, the pressure exceeds the limit-pressure. Thus, the input/output unit 84 may actually indicate a warning message.

With reference to application III, the simulated predicted backpressure can be compared with the actual backpressure. Identification of a deviation may indicate an error. For example, a lower backpressure may indicate a leakage. As shown with reference sign 199 in FIG. 5, diagram 192, the expected pressure may lie within a range of expected values. The diagram 192 shows the case, where the actual backpressure (dashed line) is far below the expected range 199. Thus, the input/output unit 84 may actually indicate a warning message.

In the following, yet another exemplary embodiment of the invention will be explained which takes actions to prevent overpressure and pressure shocks.

In particular, such embodiments may extrapolate current conditions to prevent or warn the user that an overpressure may occur.

When a fluid drive 20 (such as a pump) is turned on and a user modifies the flow rate outside of an analysis, for example to modify a separation method, it may be advantageous to have an estimate of the approximate pressure that will result from the flow rate increase to prevent this modification or at least warn the user.

In a conventional approach, the sample separation apparatus may run for example at a flow rate of 0.2 ml/min at a pressure of 300 bar on a sample separation apparatus that is suited for 600 bar. A user may now want to increase the flow rate to 0.3 ml/min, but may type in accidentally 3 ml/min. In a conventional approach, the sample separation apparatus may just apply the 3 ml/min to the pump and the pressure will rise so quickly that the user cannot react before one or more modules of the sample separation apparatus get damaged or the pump shuts down due to a high pressure error. However, there may be some delay between the actual pressure being too high and a reaction of the software-controlled sample separation apparatus.

In order to avoid such shortcomings, an exemplary embodiment of the invention may take the current conditions (in the present example a pressure of 300 bar at a flow rate of 0.2 ml/min) and derive therefrom an expectation or a prediction for any given flow rate change. When the user types in a flow rate of 3 ml/min, it may be possible to already linearly extrapolate to a pressure of 4500 bar at 3 ml/min which is several times higher than the maximum pressure tolerated by the sample separation apparatus 10. Therefore, the sample separation apparatus 10 may refuse acceptance of this value or give a warning (for example a visualization of the maximum system or column pressure and the expected pressure behavior). Advantageously, such an embodiment may consider a modelled or empirical system knowledge that may be used to prognose the pressure course based on a user action. Furthermore, it may be possible to take actions to prevent the action or at least warn the user. Thus, a process may be implemented between sending a command and applying it in a software-based control that checks if the command is valid.

In an embodiment, it may also be possible to implement a mechanism where individual pressure limits can be defined for different parts of the flow path (for example detector 50 may have a maximum pressure rating of 60 bar, and this can be written for example in a tag). It may also be possible to predict or measure the backpressure at those different locations and to define an acceptable flow corridor that complies with or does not violate any of the given limits.

In yet another exemplary embodiment, it may be advantageously possible to use historic data to estimate a pressure behavior.

The aforementioned pressure extrapolation may be further improved for a scenario in which currently no flow is applied and a user wants to start pumping with an unsuitable flow rate. However, based on knowledge about the pressure for a given set of conditions (for example solvents, flow rate, temperature, separation column) from previous measurements, it may be possible to retrieve or derive information about tolerated flow rates and to roughly estimate the pressure build up when turning on the flow. Based on this information, it may be possible to prevent a setting of unsuitable flow rates or warn the user.

In still another exemplary embodiment, it may be advantageously possible to apply a flow reduction based on a non-acceptable behavior.

When a user conventionally purges a pump of a sample separation apparatus with a manual purge valve, the system may also accept very high flow rates as the restriction of this path is rather low. However, pressure may rise quickly as soon as the purge valve gets closed and the pump is still running at the high flow rate. Flow reduction may be already implemented in the pump, but this mechanism can fail for a very steep pressure increase and it may reduce the flow rate only to the maximum allowed system pressure. However, a column may be installed in the system as well, and it should be protected as well, so flow reduction to this maximum allowed pressure may be not sufficient. The same is valid in the case of any interaction on flow path, such as, for example changing fluidic path under flow, tightening of leaky connections, operating any other valve in the flow path, adding a flow from an auxiliary pump, etc.

In view of the foregoing, an exemplary embodiment of the invention provides improvements over such conventional systems as described in the following:

When the pressure behavior for a previous period of time is known, it may be possible to derive acceptable values for the speed of the change of the pressure P over time t, i.e. for the P′(t). Also the speed of the change of the pressure speed P′(t) over time t, i.e. P″(t) and optionally also higher derivatives may be considered when evaluating a typical pressure change or defining an acceptable pressure change. The acceptable limits may also include the duration of the pressure state, for example P″ of 1000 bar/s² may be tolerated for only 0.1 s and then require a sharper braking than 100 bar/s² experienced 1 s long. This evaluation of the typical or defining the acceptable pressure variations may take into account or be based on a correlation with the repetitive motion of pistons of the pump, such that for different stroke phases or different piston positions different limits apply. Specifically a pressure pattern over one or more strokes may be a basis for an evaluation of the typical pattern and permitted pressure changes. A maximum tolerated pressure change may thus be varying depending on actual piston position or stroke phase. For example, this can be ΔP/Δt around the piston position in previous stroke(s) times, a safety factor, or just pressure deviation (ΔP compared to previous stroke(s)). This may increase the sensitivity to changes, and it may be possible to perform a flow reduction much earlier and even more thoroughly. Such a pressure limitation control algorithm may process the pressure itself, its first and optionally higher derivatives over time, piston positions, stroke phase as time-dependent parameters along with static parameters, such as the (in particular hydraulic) system configuration. This algorithm can be executed by control unit 70 or processor 100, preferably by an AI (artificial intelligence) based controller, capable of automatically adjusting the acceptance criteria based on long-term or continuous observation and evaluation of the parameter set and system operation, optionally including evaluation of corrective interaction by a user as a possible sign of a possibly inacceptable pressure event.

When identifying that the pressure deviates too much from the previous stroke(s), it may be possible to reduce the flow rate. After this initial flow rate reduction, it may be possible to check the deviation from past behavior again to see if the flow reduction was sufficient. If not, it may be possible to reduce the flow rate even more, but this time this may be done based on the effect of the previous flow reduction on the pressure behavior. Hence, it may be possible to all learn from iteration to iteration how fast the flow has to be reduced to not violate the maximum tolerated pressure change or deviate not too much from previous pump cycles.

Depending on the duration of pressure spikes (for example from valve switching) and the magnitude of initial flow rate reduction, such embodiments may be rather tolerant towards short-lived events. Furthermore, due to system knowledge, the sample separation apparatus 10 may be aware when for example an automatic valve gets switched and may deactivate the flow reduction mechanism for such an event.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control unit 70 or processor 100 schematically depicted in FIG. 1 or 2. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), field-programmable gate arrays (FPGAs), or application specific integrated circuits (ASICs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control unit 70 or processor 100 schematically depicted in FIG. 1 or 2), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

1. A process of controlling a sample separation apparatus for separating a fluidic sample, the process comprising:
determining whether the sample separation apparatus is appropriate for carrying out a predefined operation by simulating the operation of the sample separation apparatus; and
taking an action depending on a result of the determining.

2. The process according to claim 1, wherein, when the result of the determining is that the sample separation apparatus is appropriate for carrying out the predefined operation, the process comprises taking an action of at least one selected from the group consisting of: indicating operational readiness for controlling the sample separation apparatus for carrying out the predefined operation; and carrying out the predefined operation.

3. The process according to claim 1, comprising at least one of the following features:
wherein, when the result of the determining is that the sample separation apparatus is not appropriate for carrying out the predefined operation, the process comprises taking an action of at least one selected from the group consisting of: outputting a warning; stopping operation of the sample separation apparatus; modifying the predefined operation for rendering the sample separation apparatus appropriate for carrying out the modified operation; and controlling the sample separation apparatus for not carrying out the predefined operation;
wherein the process comprises further determining whether the sample separation apparatus is appropriate for carrying out an alternative predefined operation, and taking an according action in dependence of a result of the further determining.

4. The process according to claim 1, comprising one of:
wherein the process comprises simulation of at least one operation parameter and taking the action of delaying sample separation until the simulation indicates that all simulated operation parameters have reached a predefined range of acceptance and/or have reached a predefined equilibrium state;
wherein the process comprises simulation of a temperature at a sample separation unit of the sample separation apparatus, and taking the action of delaying sample separation until the simulation indicates that the simulated temperature has reached a value within a predefined range of acceptance and/or has reached a predefined equilibrium state.

5. The process according to claim 1, wherein the process comprises determining by simulation of at least one operation parameter whether all simulated operation parameters remain within a predefined range of acceptance during carrying out the predefined operation.

6. The process according to claim 1, wherein the process comprises simulating a behavior of at least one operation parameter at at least part of the sample separation apparatus during the operation, wherein a range of acceptance is a function of time or another process progress descriptor.

7. The process according to claim 6, wherein the process comprises, when at least one operation parameter is simulated and the behavior of all simulated operation parameters indicates that the sample separation apparatus is appropriate for carrying out the predefined operation, taking an action of at least one selected from the group consisting of: indicating operational readiness for controlling the sample separation apparatus for carrying out the predefined operation; and carrying out the predefined operation.

8. The process according to claim 5, wherein the process comprises simulating a behavior of the at least one operation parameter at a sample separation unit and/or in an interior of a temperature control chamber accommodating a sample separation unit of the sample separation apparatus.

9. The process according to claim 1, wherein the process comprises, based on a result of the simulation, at least one of: predicting a behavior of at least one operation parameter; predicting a delay time after which all predicted operation parameters will have reached a predefined equilibrium state or a predefined range.

10. The process according to claim 9, comprising one of:
wherein the process comprises proposing or determining a modified operation of the sample separation apparatus, based on a result of the prediction;
wherein the process comprises proposing or determining a modified operation of the sample separation apparatus for reducing the delay time, based on a result of the prediction;
wherein the process comprises proposing or determining a modified heating profile of a sample separation unit of the sample separation apparatus, based on a result of the prediction.

11. The process according to claim 1, wherein the process comprises determining whether the sample separation apparatus is appropriate for carrying out a predefined operation in form of a separation method, by simulating execution of the separation method on the sample separation apparatus for separating the fluidic sample.

12. The process according to claim 11, wherein the process comprises determining whether the simulated execution of the separation method on the sample separation apparatus results in a value of at least one operation parameter which is outside of a predefined range of acceptance.

13. The process according to claim 12, wherein the process comprises determining that the sample separation apparatus is not appropriate when the value is outside of the predefined range of acceptance.

14. The process according to claim 11, comprising one of:
wherein the process comprises simulating execution of the separation method on the sample separation apparatus under consideration of at least one user input value of at least one operation parameter;
wherein the process comprises simulating execution of the separation method on the sample separation apparatus under consideration of at least one user input value relating to a flow rate.

15. The process according to claim 4, comprising at least one of the following features:
wherein the at least one operation parameter comprises a temperature;
wherein the at least one operation parameter comprises a pressure;
wherein the at least one operation parameter relates to a sample separation unit of the sample separation apparatus.

16. The process according to claim 1, comprising at least one of the following features:
wherein the process comprises: determining by simulation whether the sample separation apparatus is ready for starting separation of the fluidic sample; and taking the action of indicating operational readiness for starting separation of the fluidic sample by the sample separation apparatus only after having determined that the sample separation apparatus is ready for starting separation of the fluidic sample;
wherein the process comprises determining by simulation that the sample separation apparatus is not appropriate for carrying out the predefined operation when a pressure value at at least part of the sample separation apparatus, obtained during simulated execution of the predefined operation of the sample separation apparatus, is above at least one predefined pressure limit;
wherein the process comprises determining by simulation that the sample separation apparatus is not appropriate for carrying out the predefined operation when a pressure value at at least part of the sample separation apparatus, obtained during simulated execution of the predefined operation of the sample separation apparatus, is above at least one predefined pressure limit, wherein the process comprises carrying out the simulation for analyzing pressure under consideration of a flow rate related to the predefined operation;
wherein the process comprises determining whether the sample separation apparatus is appropriate for carrying out the predefined operation under consideration of a predetermined characteristic behavior of a mobile phase;
wherein the process comprises determining whether the sample separation apparatus is appropriate for carrying out the predefined operation under consideration of a predetermined characteristic behavior of a mobile phase, under consideration of a predetermined transient response of the mobile phase after startup of the sample separation apparatus;
wherein the process comprises: detecting detection data being indicative of a present value of at least one operation parameter at the sample separation apparatus; and determining whether the sample separation apparatus is appropriate for carrying out the predefined operation by simulating a future behavior of the at least one operation parameter during carrying out the operation under consideration of the detection data;
wherein the process comprises determining whether the sample separation apparatus is appropriate for carrying out the predefined operation by simulating the process of separating the fluidic sample by the operation carried out on the sample separation apparatus;
wherein the process comprises determining whether the sample separation apparatus is appropriate for carrying out the predefined operation by simulating a future behavior of at least one operation parameter when carrying out the operation on the sample separation apparatus with a presently modified value of the at least one operation parameter;
wherein simulating comprises extrapolating a behavior of at least one operation parameter to the future based on a present and/or past behavior of the at least one operation parameter;
wherein the process comprises simulating the operation on the sample separation apparatus under consideration of at least one of the group consisting of empiric data, expert rules, a theoretical model, and a monitoring of an actual course of at least one operation parameter corresponding to the predefined operation;
wherein the process comprises simulating the operation on the sample separation apparatus by carrying out a numerical analysis;
wherein the process comprises simulating the operation on the sample separation apparatus by carrying out a numerical analysis selected from the group consisting of: a finite element method analysis; a finite difference method analysis; a boundary element method analysis; a control volume method analysis; and a random walk method analysis;
wherein the process comprises additionally determining whether an exterior manipulation of the sample separation apparatus influences appropriateness of the sample separation apparatus for carrying out the predefined operation; and taking an action when the result of the additional determination is that the manipulated sample separation apparatus is not or no more appropriate for carrying out the predefined operation;
wherein the process comprises additionally determining whether an exterior manipulation of the sample separation apparatus influences appropriateness of the sample separation apparatus for carrying out the predefined operation; and taking an action when the result of the additional determination is that the manipulated sample separation apparatus is not or no more appropriate for carrying out the predefined operation; wherein the action is an automated action for again rendering the manipulated sample separation apparatus appropriate for carrying out the predefined operation;
wherein the process comprises additionally determining whether an exterior manipulation of the sample separation apparatus influences appropriateness of the sample separation apparatus for carrying out the predefined operation; and taking an action when the result of the additional determination is that the manipulated sample separation apparatus is not or no more appropriate for carrying out the predefined operation; wherein the action is an automated action for reducing a flow rate, for again rendering the manipulated sample separation apparatus appropriate for carrying out the predefined operation;
wherein the process comprises additionally determining whether an exterior manipulation of the sample separation apparatus influences appropriateness of the sample separation apparatus for carrying out the predefined operation; and taking an action when the result of the additional determination is that the manipulated sample separation apparatus is not or no more appropriate for carrying out the predefined operation; wherein the action is an action for reducing a pressure below a predefined pressure limit, for again rendering the manipulated sample separation apparatus appropriate for carrying out the predefined operation;
wherein simulating the operation of the sample separation apparatus comprises an analysis of how the sample separation apparatus would behave if the predefined operation was executed on the sample separation apparatus;
wherein simulating the operation of the sample separation apparatus comprises a numerical analysis;
wherein the process comprises simulating the process of separating the fluidic sample by the operation carried out on the sample separation apparatus to derive at least one selected from the group consisting of: a theoretical course of a temperature; a theoretical course of a pressure; and a theoretical separation result by a numerical analysis;
wherein the process comprises simulating theoretically a behavior of the sample separation apparatus when executing the predefined operation
wherein the process comprises simulating theoretically a behavior of the sample separation apparatus when executing the predefined operation prior to its actual execution;
wherein simulating the operation of the sample separation apparatus comprises simulating a course over time of the operation executed on the sample separation apparatus;
wherein simulating the operation of the sample separation apparatus comprises simulating a course over time of at least one operation parameter when the operation is executed on the sample separation apparatus.

17. A computer-readable medium, in which a computer program for controlling a sample separation apparatus for separating a fluidic sample is stored, wherein the computer program, when being executed by a processor, is configured to carry out or control the process according to claim 1.

18. A program element for controlling a sample separation apparatus for separating a fluidic sample, wherein the program element, when being executed by a processor, is configured to carry out or control the process according to claim 1.

19. A sample separation apparatus for separating a fluidic sample, the sample separation apparatus comprising:
a fluid drive for driving a mobile phase and the fluidic sample when injected in the mobile phase;
a sample separation unit for separating the fluidic sample in the mobile phase; and
a control unit configured for controlling the sample separation apparatus by carrying out the process according to claim 1.

20. The sample separation apparatus according to claim 19, wherein the sample separation apparatus comprises at least one of the following features:
the sample separation apparatus is configured as a chromatography sample separation apparatus;
the sample separation apparatus comprises a detector configured to detect the separated fluidic sample;
the sample separation apparatus comprises a fractionating unit configured to collect separated fractions of the fluidic sample;
the sample separation apparatus comprises an injector configured to inject the fluidic sample in the mobile phase.
